(19) United States
(12) Patent Application Publication
(10) Pub. No.: US 2023/0349222 A1
(43) Pub. Date: Nov. 2, 2023

(54) AUTONOMOUS VEHICLE

(71) Applicant: TOYOTA JIDOSHA KABUSHIKI KAISHA, Toyota-shi Aichi-ken (JP)

(72) Inventor: Keisuke MIWA, Toyota-shi Aichi-ken (JP)

(73) Assignee: TOYOTA JIDOSHA KABUSHIKI KAISHA, Toyota-shi Aichi-ken (JP)

(21) Appl. No.: 18/136,965

(22) Filed: Apr. 20, 2023

(30) Foreign Application Priority Data
Apr. 27, 2022 (JP) 2022-073768

(51) Int. Cl. E05F 15/73; B60R 25/20; B60R 25/01; E05F 15/40

(52) U.S. Cl. CPC E05F 15/73; B60R 25/20; B60R 25/01; E05F 15/40; E05F 2015/767; E05Y 2400/45; E05Y 2400/52; E05Y 2900/531

(57) ABSTRACT

An autonomous vehicle includes: a stop prohibition area that is set in a vicinity of a door; a camera; a door opening and closing control unit performs automatic opening and closing of the door in a case where it is determined that the door is automatically openable and closable; and a door opening and closing switch that is provided in the vicinity of the door and opens and closes the door upon operation by an occupant. When an operation of the door opening and closing switch is performed, the door opening and closing control unit executes opening and closing of the door based on the operation of the door opening and closing switch in preference to the automatic opening and closing of the door based on the determination on the image.

### CROSS REFERENCE TO RELATED APPLICATION

This application claims priority to Japanese Patent Application No. 2022-073768 filed on Apr. 27, 2022, which is incorporated herein by reference in its entirety including the specification, claims, drawings, and abstract.

### TECHNICAL FIELD

The present disclosure relates to door opening and closing control in an autonomous vehicle.

### BACKGROUND

In an autonomous vehicle, a crewman such as a driver is not in the vehicle, and it is necessary to monitor a state of a vehicle interior. For example, JP 2020-3935 A proposes a system that is provided with a camera for capturing an image of a vehicle interior, and monitors a state of the vehicle interior and behaviors of a passenger.

### SUMMARY

Opening and closing of a door is also performed automatically in the autonomous vehicle. In order to automatically open and close the door, it is necessary to set a stop prohibition area near the door and to open and close the door after confirming, based on an image or the like, that a person or an object does not enter the stop prohibition area. In this case, when it is detected that a person or an object enters the stop prohibition area, opening and closing of the door are prohibited.

On the other hand, the autonomous vehicle is provided with a door opening and closing switch that opens and closes the door by a manual operation. The door opening and closing switch may be provided in a vicinity of the door, and an occupant may enter the stop prohibition area when operating the door opening and closing switch. In this case, the opening and closing of the door based on the operation of the door opening and closing switch performed by the occupant interferes with the automatic door opening and closing prohibition due to the entry of the occupant into the stop prohibition area, and the door cannot be opened and closed as intended by the occupant.

Accordingly, an object of the present disclosure is to open and close a door as intended by an occupant in an autonomous vehicle.

An autonomous vehicle according to the present disclosure includes: a stop prohibition area that is set in the vicinity of a door; an imaging device that captures an image of an area including the stop prohibition area; a door opening and closing control unit that analyzes the image to determine whether the door is automatically openable and closable, and performs automatic opening and closing of the door in a case where it is determined that the door is automatically openable and closable; and a door opening and closing switch that is provided in the vicinity of the door and opens and closes the door upon operation by an occupant. When an operation of the door opening and closing switch is performed, the door opening and closing control unit executes opening and closing of the door based on the operation of the door opening and closing switch in preference to the automatic opening and closing of the door based on the determination on the image.

As described above, when the operation of the door opening and closing switch is performed, the opening and closing of the door based on the operation of the door opening and closing switch is executed in preference to the automatic opening and closing of the door based on the determination on the image, and thus interference between the door opening and closing based on the operation of the door opening and closing switch performed by an occupant and the automatic opening and closing of the door can be prevented, and the door can be opened and closed as intended by the occupant.

In the autonomous vehicle according to the present disclosure, the door opening and closing control unit may analyze the image to detect whether a target enters the stop prohibition area, may determine that the door is automatically openable and closable and may perform the automatic opening and closing of the door in a case where the target does not enter the stop prohibition area, may determine that the door is not automatically openable and closable and may not perform the automatic opening and closing of the door in a case where the target enters the stop prohibition area, and may perform the opening and closing of the door based on the operation of the door opening and closing switch in a case where it is determined that the door is not automatically openable and closable and the operation of the door opening and closing switch is performed.

Accordingly, even when the occupant enters the stop prohibition area, the door can be opened and closed by the operation of the door opening and closing switch performed by the occupant.

In the autonomous vehicle according to the present disclosure, the automatic opening and closing of the door may be stopped and the opening and closing of the door may be performed based on the operation of the door opening and closing switch in a case where the operation of the door opening and closing switch is performed during the automatic opening and closing of the door.

Accordingly, the door can be opened and closed as intended by the occupant even in a case where the operation of the door opening and closing switch is performed by the occupant during the automatic opening and closing of the door.

In the autonomous vehicle according to the present disclosure, the stop prohibition area may be set in a vehicle interior, and the imaging device and the door opening and closing switch may be provided in the vehicle interior.

Accordingly, the door can be opened and closed from the vehicle interior as intended by the occupant in the vehicle.

In the autonomous vehicle according to the present disclosure, the stop prohibition area may include a vehicle interior stop prohibition area set in a vehicle interior and a vehicle exterior stop prohibition area set in a vehicle exterior, the imaging device may include a vehicle interior imaging device that captures a vehicle interior image of a vehicle interior area including the vehicle interior stop prohibition area, and a vehicle exterior imaging device that captures a vehicle exterior image of a vehicle exterior area including the vehicle exterior stop prohibition area, the door opening and closing switch may be individually provided at the vehicle interior and the vehicle exterior, the door opening and closing control unit may analyze the vehicle interior image and the vehicle exterior image to determine whether the door is automatically openable and closable, and may perform automatic opening and closing of the door in a case where it is determined that the door is automatically openable and closable, and when an operation of one door opening and closing switch of the plurality of door opening and closing switches is performed, the opening and closing of the door based on the operation of the one door opening and closing switch may be executed in preference to the automatic opening and closing of the door based on the determination on the vehicle interior image and the vehicle exterior image.

Accordingly, the door can be opened and closed as intended by a passenger in the vehicle interior or in the vehicle exterior.

In the autonomous vehicle according to the present disclosure, the door opening and closing control unit may analyze the vehicle interior image and the vehicle exterior image to detect whether a target enters the vehicle interior stop prohibition area or the vehicle exterior stop prohibition area, may determine that the door is automatically openable and closable, and may perform the automatic opening and closing of the door in a case where the target does not enter the vehicle interior stop prohibition area or the vehicle exterior stop prohibition area, may determine that the door is not automatically openable and closable, and may not perform the automatic opening and closing of the door in a case where the target enters the vehicle interior stop prohibition area or the vehicle exterior stop prohibition area, and may perform the opening and closing of the door based on an operation of one door opening and closing switch of the plurality of door opening and closing switches in a case where it is determined that the door is not automatically openable and closable and the operation of the one door opening and closing switch is performed.

In a case where an operation of one door opening and closing switch of the plurality of door opening and closing switches is performed during the automatic opening and closing of the door, the automatic opening and closing of the door may be stopped, and the opening and closing of the door may be performed based on the operation of the one door opening and closing switch.

According to the present disclosure, in an autonomous vehicle, a door can be opened and closed as intended by an occupant.

### BRIEF DESCRIPTION OF DRAWINGS

Embodiment(s) of the present disclosure will be described based on the following figures, wherein:

FIG. 1 is a perspective view showing an appearance of an autonomous vehicle according to an embodiment;

FIG. 2 is a plan view showing a vehicle interior of the autonomous vehicle shown in FIG. 1;

FIG. 3 is a block diagram showing a system configuration of the autonomous vehicle according to the embodiment;

FIG. 4 is a flowchart showing an opening and closing operation of a door performed by a door opening and closing control unit shown in FIG. 3;

FIG. 5 is a flowchart showing operations of the door opening and closing control unit shown in FIG. 3 in a case where a door opening and closing switch is operated during an automatic opening operation of the door;

FIG. 6 is a flowchart showing operations of the door opening and closing control unit shown in FIG. 3 in a case where the door opening and closing switch is operated during an automatic closing operation of the door;

FIG. 7 is a plan view showing a vehicle interior and a vehicle exterior of an autonomous vehicle according to another embodiment; and

FIG. 8 is a block diagram showing a system configuration of the autonomous vehicle shown in FIG. 7.

### DESCRIPTION OF EMBODIMENTS

Hereinafter, an autonomous vehicle 10 according to an embodiment will be described with reference to the drawings. An arrow FR, an arrow UP, and an arrow LH illustrated in the drawings respectively indicate a forward direction (traveling direction), an upward direction, and a leftward direction of the autonomous vehicle 10. The directions opposite to the arrows FR, UP, and LH indicate a rearward direction, a downward direction, and a rightward direction of a vehicle, respectively. In the following description, unless otherwise specified, a front-rear direction, a left-right direction, and an up-down direction, which are simply used for the description, refer to front-rear in a vehicle front-rear direction, left-right in a vehicle left-right direction (vehicle width direction), and up-down in a vehicle up-down direction, respectively.

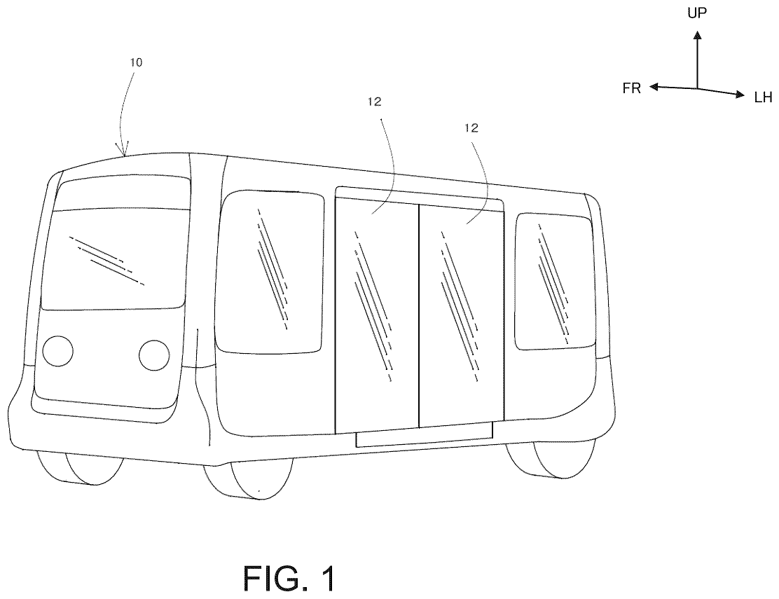

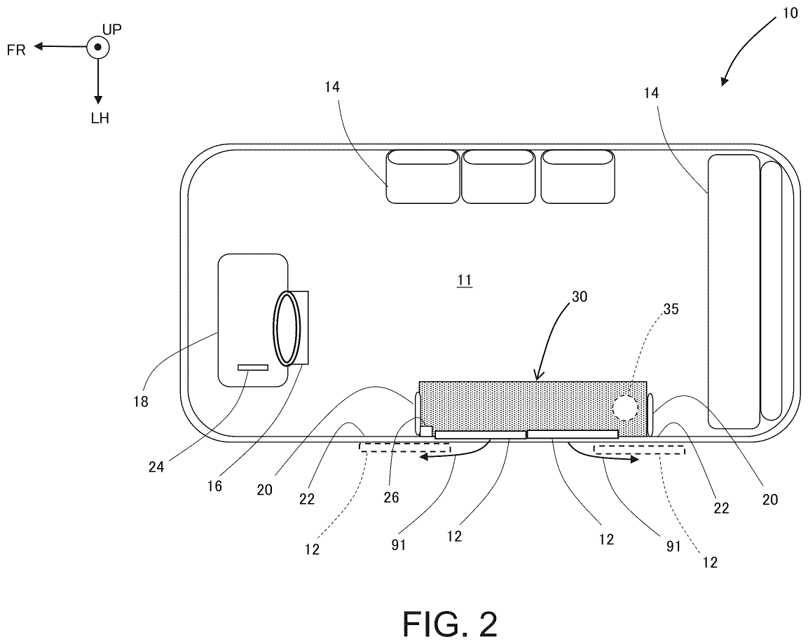

FIG. 1 shows an example of the autonomous vehicle 10. As shown in FIG. 1, the autonomous vehicle 10 is an autonomous battery electric vehicle (BEV), and is a bus provided with double doors 12 and 12 for passengers to get on and off on a left side surface thereof. The door 12 is an out-slide door, and slides outward of the vehicle as indicated by an arrow 91 in FIG. 2, and is positioned outside a vehicle side surface indicated by a broken line in FIG. 2 when the door 12 is opened.

Next, a vehicle interior 11 of the autonomous vehicle 10 will be described with reference to FIG. 2. As shown in FIG. 2, in the vehicle interior 11, seats 14 are provided on the right (opposite to the door 12) and the rear, and a driver seat 16 and a manual driving device 18 are provided on the front. The driver seat 16 and the manual driving device 18 are used in manual driving, and are not used in autonomous driving. A driving mode changeover switch 24 that switches between autonomous driving and manual driving is attached to the manual driving device 18. When the autonomous vehicle 10 performs autonomous driving, a crewman such as a driver is not in the vehicle, in principle.

A stop prohibition area 30 in which a passenger is prohibited from stopping or standing is set on a vehicle interior side of the doors 12. The stop prohibition area 30 has a rectangular shape indicated by hatching in FIG. 2 in a top view, and is a three-dimensional rectangular parallelepiped area that extends from a floor surface of the vehicle interior 11 to the vicinity of upper ends of the doors 12. In a case where a target such as a passenger or luggage is present in the stop prohibition area 30, automatic opening of the doors 12 is prohibited, and movement is prompted by an alarm or the like.

In addition, a camera 35 is provided at a ceiling portion of the upper vehicle interior 11 in the rear of the stop prohibition area 30. The camera 35 is an imaging device for capturing an image of the entire vehicle interior including the stop prohibition area 30 set inside the doors 12, and is implemented by a wide-angle camera. The number of cameras 35 may be one or two.

Handrails 20 are provided at boundary portions of the stop prohibition area 30 in the front-rear direction. The handrails 20 each protrude inward from a side wall 22 of the vehicle interior 11. An upper end and a lower end of the handrail 20 are attached to the side wall 22 of the vehicle interior 11, and the handrail 20 is a U-shaped handrail that extends inward from both ends and has an intermediate portion extending parallel to the side wall 22 in the up-down direction.

A door opening and closing switch 26 is attached to a vicinity of an opening of the door 12 of the vehicle interior 11. The door opening and closing switch 26 opens and closes the doors 12 upon operation by an occupant or a passenger in the autonomous vehicle 10. The door opening and closing switch 26 is attached to the side wall 22 positioned in the stop prohibition area 30 of the vehicle interior 11. The door opening and closing switch 26 may include, for example, a door opening button and a door closing button.

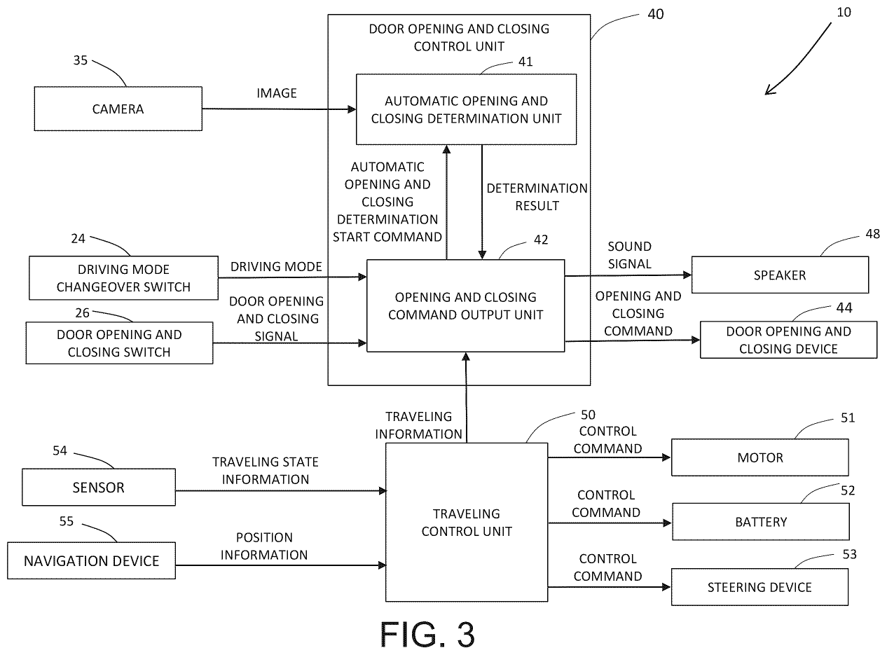

Next, a system configuration of the autonomous vehicle 10 will be described with reference to FIG. 3. As shown in FIG. 3, the autonomous vehicle 10 is an autonomous battery electric vehicle (BEV) that uses a motor 51 and a battery 52 as driving sources. The autonomous vehicle 10 includes the motor 51, the battery 52, a steering device 53, a sensor 54, a navigation device 55, and a traveling control unit 50. The autonomous vehicle 10 further includes a door opening and closing control unit 40, a door opening and closing device 44, a speaker 48, and the camera 35, the driving mode changeover switch 24 and the door opening and closing switch 26 described above.

First, the traveling control unit 50 will be described. The traveling control unit 50 is implemented by a computer including therein a CPU that performs information processing and a memory that stores a program and control data. The motor 51, the battery 52, the steering device 53, the sensor 54, and the navigation device 55 are connected to the traveling control unit 50. The motor 51, the battery 52, and the steering device 53 operate according to a control command from the traveling control unit 50.

The sensor 54 detects traveling state information such as a speed and an acceleration of the autonomous vehicle 10 and outputs the traveling state information to the traveling control unit 50. The navigation device 55 generates position information such as a current position and a traveling route of the autonomous vehicle 10 based on a GPS signal received from a GPS satellite, and outputs the position information to the traveling control unit 50. The traveling control unit 50 controls the motor 51, the battery 52, and the steering device 53 based on the position information received from the navigation device 55 and the traveling state information received from the sensor 54, and causes the autonomous vehicle 10 to autonomously travel.

Next, a configuration of the door opening and closing control unit 40 will be described. The door opening and closing control unit 40 is implemented by a computer including therein a CPU that performs information processing, and a memory that stores a program and control data. The door opening and closing control unit 40 includes two functional blocks, that is, an automatic opening and closing determination unit 41 and an opening and closing command output unit 42. The functional blocks are implemented by the CPU executing the program stored in the memory. The camera 35 is connected to the automatic opening and closing determination unit 41 of the door opening and closing control unit 40, and the driving mode changeover switch 24, the door opening and closing switch 26, the speaker 48, and the door opening and closing device 44 are connected to the opening and closing command output unit 42. The opening and closing command output unit 42 is connected to the traveling control unit 50.

The camera 35 captures an image of the vehicle interior including the stop prohibition area 30 and outputs the image to the automatic opening and closing determination unit 41. The driving mode changeover switch 24 outputs a signal indicating whether a driving mode is the autonomous driving mode or the manual driving mode to the opening and closing command output unit 42. The door opening and closing switch 26 outputs a door opening signal or a door closing signal to the opening and closing command output unit 42. The speaker 48 and the door opening and closing device 44 operate according to a sound signal and an opening and closing command from the opening and closing command output unit 42.

After the automatic opening and closing determination unit 41 receives an automatic opening and closing determination start command from the opening and closing command output unit 42, the automatic opening and closing determination unit 41 analyzes the image received from the camera 35 to determine whether the doors 12 can be automatically opened and closed, and outputs a determination result to the opening and closing command output unit 42.

The automatic opening and closing determination unit 41 analyzes the image received from the camera 35 to detect whether a target such as an occupant or luggage enters the stop prohibition area 30. Then, in a case where the target does not enter the stop prohibition area 30, the automatic opening and closing determination unit 41 determines that the doors 12 can be automatically opened and closed, and outputs a determination result that the automatic opening and closing can be performed to the opening and closing command output unit 42. On the other hand, in a case where the target enters the stop prohibition area 30, the automatic opening and closing determination unit 41 determines that the doors 12 cannot be automatically opened and closed, and outputs a determination result that the automatic opening and closing cannot be performed to the opening and closing command output unit 42.

In a case where the determination result that the automatic opening and closing can be performed is received from the automatic opening and closing determination unit 41, the opening and closing command output unit 42 refers to the traveling information such as the current position and the speed of the autonomous vehicle 10 received from the traveling control unit 50, and drives the door opening and closing device 44 to perform automatic opening and closing of the doors 12 after the autonomous vehicle 10 stops at a point where the doors 12 are to be opened and closed. On the other hand, in a case where the determination result that the automatic opening and closing cannot be performed is received from the automatic opening and closing determination unit 41, the opening and closing command output unit 42 does not perform the automatic opening and closing of the doors 12.

In a case where an operation of the door opening and closing switch 26 is performed and the door opening signal or the door closing signal is received from the door opening and closing switch 26, the opening and closing command output unit 42 executes the opening and closing of the doors 12 based on the operation of the door opening and closing switch 26 in preference to the automatic opening and closing of the doors 12 based on the determination result from the automatic opening and closing determination unit 41.

That is, in a case where the determination result that the doors 12 cannot be automatically opened and closed is received from the automatic opening and closing determination unit 41, and the operation of the door opening and closing switch 26 is performed and the door opening signal or the door closing signal is received, the opening and closing command output unit 42 prioritizes the operation of the door opening and closing switch 26 and outputs an opening and closing command for the doors 12 to the door opening and closing device 44 to perform opening and closing of the doors 12.

In addition, in a case where the determination result that the doors 12 can be automatically opened and closed is received from the automatic opening and closing determination unit 41, and the operation of the door opening and closing switch 26 is performed and a door opening signal or a door closing signal is received, the opening and closing command output unit 42 also prioritizes the operation of the door opening and closing switch 26 and outputs the opening and closing command for the doors 12 to the door opening and closing device 44 to perform opening and closing of the doors 12.

In a case where the determination result that the doors 12 can be automatically opened and closed is received from the automatic opening and closing determination unit 41, and the operation of the door opening and closing switch 26 is not performed, the opening and closing command output unit 42 performs automatic opening and closing of the doors 12.

Further, in a case where the operation of the door opening and closing switch 26 is performed during the automatic opening and closing of the doors 12, the opening and closing command output unit 42 stops the automatic opening and closing of the doors 12, and performs opening and closing of the doors 12 based on the operation of the door opening and closing switch 26.

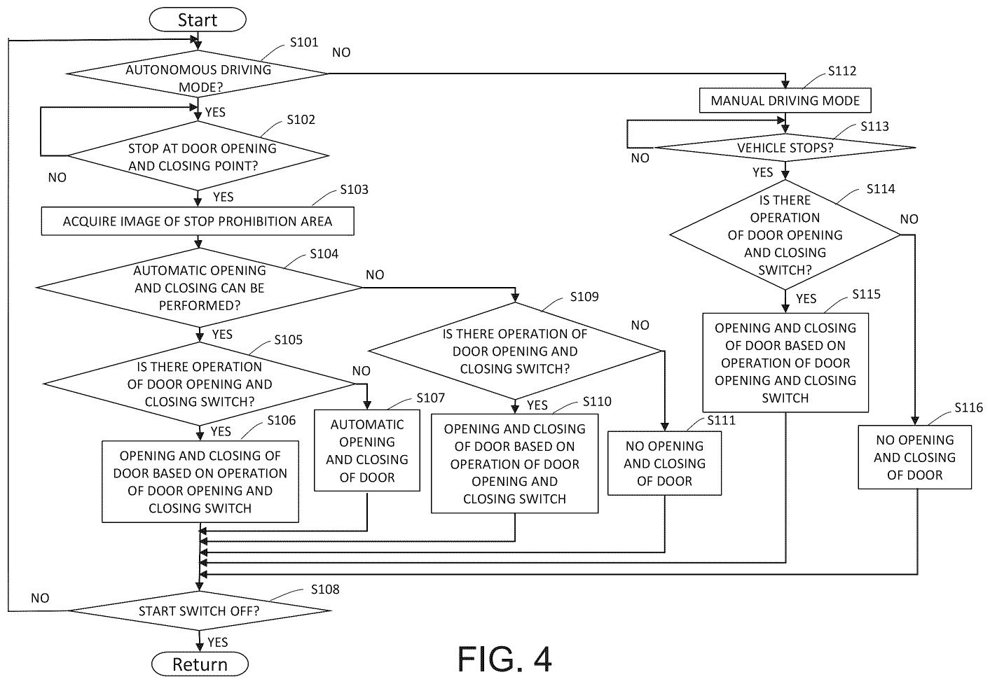

Next, the operations of the door opening and closing control unit 40 will be described with reference to FIGS. 4 to 6. The door opening and closing control unit 40 starts an operation when a start switch of the autonomous vehicle 10 is turned on.

As shown in step S101 in FIG. 4, the opening and closing command output unit 42 determines whether the driving mode received from the driving mode changeover switch 24 is the autonomous driving mode. When the opening and closing command output unit 42 determines YES in step S101 in FIG. 4, the opening and closing command output unit 42 proceeds to step S102 in FIG. 4, and waits until the autonomous vehicle 10 stops, based on the traveling information such as the current position and the speed of the autonomous vehicle 10 received from the traveling control unit 50, at a point where the doors 12 are to be opened and closed, such as a stopping point. Then, when the opening and closing command output unit 42 determines YES in step S102 in FIG. 4, the opening and closing command output unit 42 outputs an automatic opening and closing determination start command to the automatic opening and closing determination unit 41.

When the automatic opening and closing determination start command is received from the opening and closing command output unit 42, the automatic opening and closing determination unit 41 acquires an image of the vehicle interior 11 including the stop prohibition area 30 from the camera 35 in step S103 in FIG. 4, and proceeds to step S104 in FIG. 4. In step S104 in FIG. 4, the automatic opening and closing determination unit 41 analyzes the image acquired from the camera 35 to detect whether a target such as an occupant or luggage enters the stop prohibition area 30. Then, in a case where the target does not enter the stop prohibition area 30, the automatic opening and closing determination unit 41 determines YES in step S104 in FIG. 4, and outputs a determination result that the automatic opening and closing can be performed to the opening and closing command output unit 42. On the other hand, in a case where the target enters the stop prohibition area 30, the automatic opening and closing determination unit 41 determines NO in step S104 in FIG. 4, and outputs a determination result that the automatic opening and closing cannot be performed to the opening and closing command output unit 42.

Here, there are various methods for detecting whether a target such as an occupant or luggage enters the stop prohibition area 30 based on an image received from the camera 35. For example, in a case where there is one camera 35, the handrail 20 is used as a reference object, and a positional relationship between a part of the occupant or luggage and the handrail 20 may be detected based on the image acquired from the camera 35 to determine whether the target enters the stop prohibition area 30. In this case, it may be determined that there is an entry into the stop prohibition area 30 in a case where a part of the occupant or the luggage is positioned in front of the handrail 20 in the image, and that there is no entry into the stop prohibition area 30 in a case where a part of the occupant or the luggage is positioned behind the handrail 20 in the image.

In a case where the determination result that the automatic opening and closing can be performed is received from the automatic opening and closing determination unit 41, the opening and closing command output unit 42 determines, in step S105 in FIG. 4, whether the door opening and closing switch 26 is operated and a door opening signal or a door closing signal is received. In a case where the door opening and closing switch 26 is operated, the opening and closing command output unit 42 determines YES in step S105 in FIG. 4, proceeds to step S106 in FIG. 4, and outputs a command for opening or closing of the doors 12 to the door opening and closing device 44 based on the door opening signal or the door closing signal from the door opening and closing switch 26. The door opening and closing device 44 opens and closes the doors 12 based on the command received from the opening and closing command output unit 42. Then, when the opening and closing of the doors 12 is finished, the opening and closing command output unit 42 proceeds to step S108 in FIG. 4.

In a case where the door opening and closing switch 26 is not operated, the opening and closing command output unit 42 determines NO in step S105 in FIG. 4 and proceeds to step S107 in FIG. 4 to perform automatic opening and closing of the doors 12. Then, when the opening and closing of the doors 12 is finished, the opening and closing command output unit 42 proceeds to step S108 in FIG. 4.

On the other hand, in a case where the determination result that the automatic opening and closing cannot be performed is received from the automatic opening and closing determination unit 41, the opening and closing command output unit 42 determines, in step S109 similar to step S105 in FIG. 4, whether the door opening and closing switch 26 is operated. In a case where YES is determined in step S109 in FIG. 4, the opening and closing command output unit 42 proceeds to step S110 in FIG. 4 to perform opening and closing of the doors 12 based on the signal from the door opening and closing switch 26. Then, when the opening and closing of the doors 12 is finished, the opening and closing command output unit 42 proceeds to step S108 in FIG. 4.

In a case where the doors 12 cannot be automatically opened and closed and the operation of the door opening and closing switch 26 is not performed, the opening and closing command output unit 42 determines NO in step S109 in FIG. 4, does not perform opening and closing of the doors 12 in step S111 in FIG. 4, and proceeds to step S108 in FIG. 4.

In a case where the driving mode received from the driving mode changeover switch 24 is not the autonomous driving mode, the opening and closing command output unit 42 determines NO in step S101 in FIG. 4, and proceeds to step S112 in FIG. 4 to recognize the driving mode as the manual driving mode. Then, the opening and closing command output unit 42 waits in step S113 in FIG. 4 until the autonomous vehicle 10 stops based on the traveling information from the traveling control unit 50. Then, the opening and closing command output unit 42 proceeds to step S114 in FIG. 4 when the autonomous vehicle 10 stops. In a case where the door opening and closing switch 26 is operated, the opening and closing command output unit 42 proceeds to step S115 in FIG. 4 to perform opening and closing of the doors 12 based on the operation of the door opening and closing switch 26, and proceeds to step S108 in FIG. 4 when the opening and closing of the doors 12 is finished. In a case where the door opening and closing switch 26 is not operated, the opening and closing command output unit 42 determines NO in step S114 in FIG. 4, proceeds to step S116 in FIG. 4 in which the opening and closing the doors 12 is not performed, and proceeds to step S108 in FIG. 4.

In a case where the door opening and closing switch 26 is operated in step S114 in FIG. 4, the opening and closing command output unit 42 may output an automatic opening and closing determination start command to the automatic opening and closing determination unit 41 and acquire a determination result regarding whether the automatic opening and closing can be performed from the automatic opening and closing determination unit 41, and may output an alarm from the speaker 48 when the determination result that the automatic opening and closing cannot be performed is received.

The opening and closing command output unit 42 determines, in step S108 in FIG. 4, whether the start switch is turned off, and in a case where it is determined as NO in step S108 in FIG. 4, the opening and closing command output unit 42 returns to step S101 in FIG. 4 and repeatedly executes steps S101 to S116. In a case where the start switch is turned off, the processing is ended.

As described above, in the autonomous vehicle 10, when the operation of the door opening and closing switch 26 is performed, the door opening and closing based on the operation of the door opening and closing switch 26 is preferentially executed regardless of the determination result from the automatic opening and closing determination unit 41, and thus interference between the door opening and closing based on the operation of the door opening and closing switch 26 performed by the occupant and the automatic opening and closing of the doors 12 can be prevented, and the doors 12 can be opened and closed as intended by the occupant.

In the autonomous vehicle 10, even in a case where the occupant enters the stop prohibition area 30 and a determination result that the automatic opening and closing cannot be performed is output from the automatic opening and closing determination unit 41, the doors 12 can be opened and closed by the operation of the door opening and closing switch 26 performed by the occupant. Therefore, the door opening and closing switch 26 is provided on the side wall 22 of the vehicle interior 11, which is positioned in the stop prohibition area 30, and even in a case where the occupant enters the stop prohibition area 30 for the operation of the door opening and closing switch 26, the doors 12 can be opened and closed as intended by the occupant.

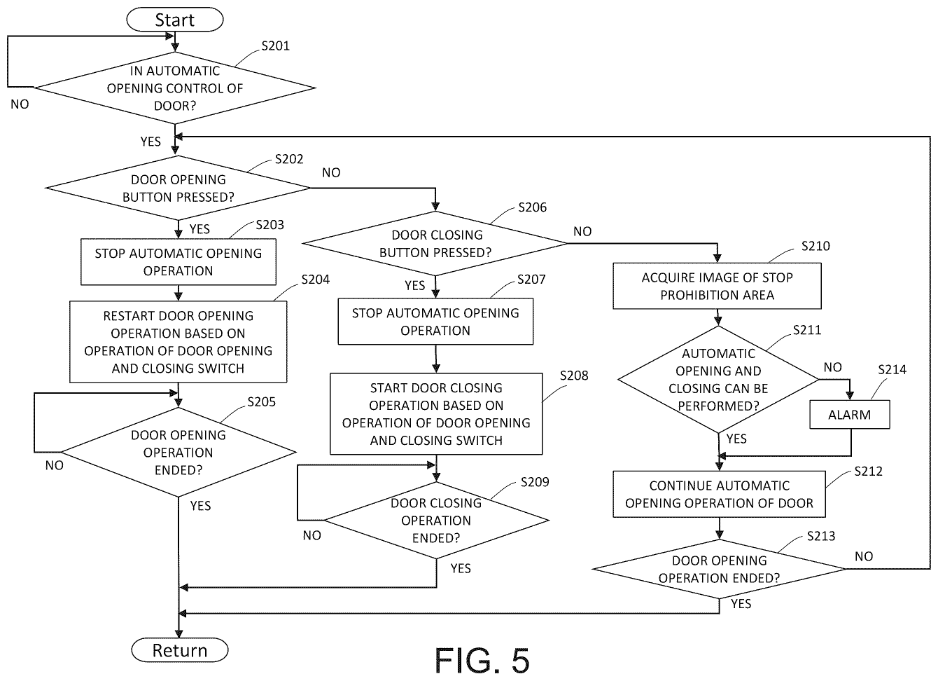

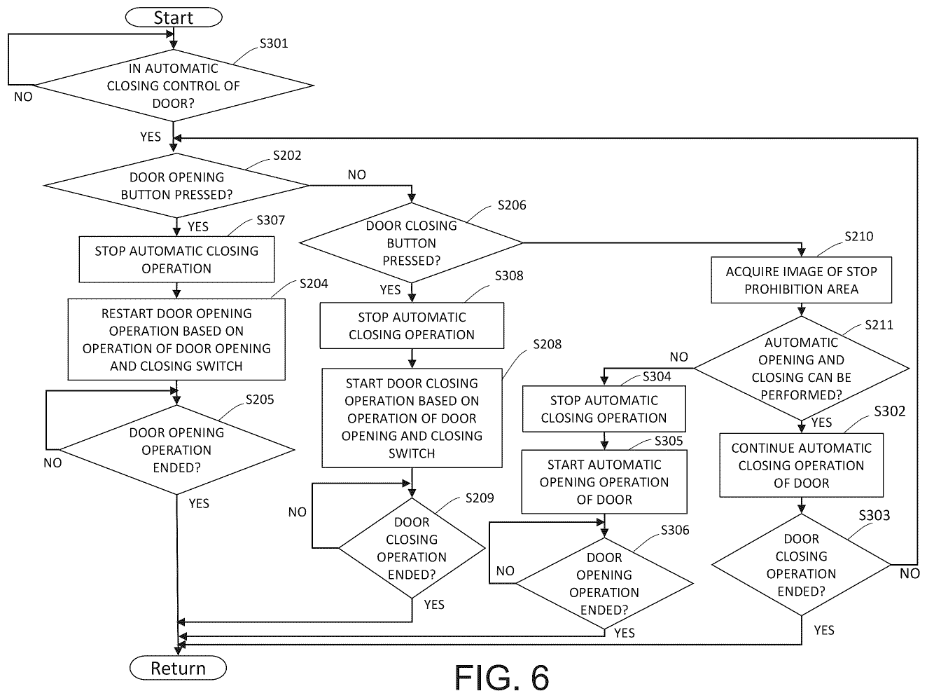

Next, an opening and closing operation of the doors 12 in a case where the door opening and closing switch 26 is operated while the doors 12 automatically opening and closing in the autonomous vehicle 10 will be described with reference to FIGS. 5 and 6.

First, the opening and closing operation of the doors 12 in a case where the door opening and closing switch 26 is operated while the door opening and closing control unit 40 performs an automatic opening operation of the doors 12 will be described with reference to FIG. 5.

As shown in step S201 in FIG. 5, the opening and closing command output unit 42 waits until the automatic opening operation of the doors 12 is started. Then, when the automatic opening operation of the doors 12 is started, the opening and closing command output unit 42 proceeds to step S202 in FIG. 5 to determine whether the door opening button is pressed. In a case where the opening and closing command output unit 42 determines NO in step S202 in FIG. 5, the opening and closing command output unit 42 proceeds to step S206 in FIG. 5 to determine whether the door closing button is pressed. In a case where the opening and closing command output unit 42 determines NO in step S206 in FIG. 5, the opening and closing command output unit 42 determines that the operation of the door opening and closing switch 26 is not performed, and outputs an automatic opening and closing determination start command to the automatic opening and closing determination unit 41.

The automatic opening and closing determination unit 41 acquires an image of the vehicle interior 11 including the stop prohibition area 30 from the camera 35 in step S210 in FIG. 5, determines whether the automatic opening and closing can be performed in step S211 in FIG. 5 similar to step S104 in FIG. 4 described above, and outputs a determination result to the opening and closing command output unit 42.

In a case where the determination result that the automatic opening and closing can be performed is received, the opening and closing command output unit 42 proceeds to step S212 in FIG. 5 to continue the automatic opening operation of the doors 12. In a case where the determination result that the automatic opening and closing cannot be performed is received, the opening and closing command output unit 42 outputs an alarm generation signal to the speaker 48 in step S214 in FIG. 5 to cause the speaker 48 to generate an alarm sound, and proceeds to step S212 in FIG. 5 to continue the automatic opening operation of the doors 12. Then, the opening and closing command output unit 42 performs the automatic opening operation of the doors 12 by repeatedly executing step S202, step S206, and step S210 to step S213 in FIG. 5 in this order until the opening operation of the doors 12 is ended.

As described above, the opening and closing command output unit 42 continues the automatic opening operation of the doors 12 in a case where the operation of the door opening and closing switch 26 is not performed during the automatic opening operation of the doors 12.

On the other hand, in a case where the door opening and closing switch 26 is operated and the door opening button is pressed during the automatic opening operation of the doors 12, the opening and closing command output unit 42 determines YES in step S202 in FIG. 5, and proceeds to step S203 in FIG. 5 to stop the automatic opening operation of the doors 12. Then, the opening and closing command output unit 42 proceeds to step S204 in FIG. 5 to restart an opening operation of the doors 12 based on the operation of the door opening and closing switch 26. Then, the opening and closing command output unit 42 waits in step S205 in FIG. 5 until the opening operation of the doors 12 is ended, and ends the processing when the opening operation of the doors 12 is ended.

Similarly, in a case where the door closing button is pressed during the automatic opening operation of the doors 12, the opening and closing command output unit 42 determines NO in step S202 in FIG. 5, determines YES in step S206 in FIG. 5, and proceeds to step S207 in FIG. 5. Then, the automatic opening operation is stopped, and the processing proceeds to step S208 in FIG. 5 to start a closing operation of the doors 12 based on the operation of the door opening and closing switch 26. Then, the opening and closing command output unit 42 waits in step S209 in FIG. 5 until the closing operation of the doors 12 is ended, and ends the processing when the closing operation of the doors 12 is ended.

Next, the opening and closing operation of the doors 12 in a case where the door opening and closing switch 26 is operated while the door opening and closing control unit 40 performs an automatic closing operation of the doors 12 will be described with reference to FIG. 6. The same steps as those described above with reference to FIG. 5 are denoted by the same step numbers and will be briefly described.

As shown in step S301 in FIG. 6, the opening and closing command output unit 42 waits until the automatic closing operation of the doors 12 is started. Then, when the automatic closing operation of the doors 12 is started, in a case where the opening and closing command output unit 42 determines NO in both step S202 and step S206 in FIG. 6, the opening and closing command output unit 42 determines that the operation of the door opening and closing switch 26 is not performed, and outputs an automatic opening and closing determination start command to the automatic opening and closing determination unit 41.

The automatic opening and closing determination unit 41 acquires an image of the vehicle interior 11 including the stop prohibition area 30 in step S210 in FIG. 6, determines, in step S211 in FIG. 6, whether automatic opening and closing can be performed, and outputs a determination result to the opening and closing command output unit 42.

When the determination result that the automatic opening and closing can be performed is received, the opening and closing command output unit 42 proceeds to step S302 in FIG. 6 to continue the automatic closing operation of the doors 12, and performs the automatic closing operation of the doors 12 by repeatedly executing step S202, step S206, step S210, step S211, step S302, and step S303 in FIG. 6 in this order until the closing operation of the doors 12 is ended. Then, when the doors 12 are closed, YES is determined in step S303 in FIG. 6, and the processing is ended.

In a case where the determination result that the automatic opening and closing cannot be performed is received, the opening and closing command output unit 42 proceeds to step S304 in FIG. 6 to stop the automatic closing operation of the doors 12, and proceeds to step S305 in FIG. 6. Then, the opening and closing command output unit 42 waits in step S306 in FIG. 6 until the opening operation of the doors 12 is ended, and ends the processing when the doors 12 are opened.

As described above, the opening and closing command output unit 42 continues the automatic closing operation of the doors 12 to close the doors 12 in a case where the automatic opening and closing can be performed during the automatic closing operation of the doors 12 and the operation of the door opening and closing switch 26 is not performed. The opening and closing command output unit 42 stops the automatic closing operation of the doors 12, and performs the automatic opening operation of the doors 12 to open the doors 12 in a case where the automatic opening and closing cannot be performed during the automatic closing operation.

On the other hand, in a case where the door opening button is pressed during the automatic closing operation of the doors 12, the automatic closing operation of the doors 12 is stopped in step S307 in FIG. 6, and the opening operation of the doors 12 is started in steps S204 and S205 in FIG. 6, similar to the automatic opening operation of the doors 12 described above with reference to FIG. 5. Then, the opening and closing command output unit 42 waits in step S205 in FIG. 6 until the opening operation of the doors 12 is ended, and ends the processing when the opening operation of the doors 12 is ended.

Similarly, in a case where the door closing button is pressed during the automatic closing operation of the doors 12, the opening and closing command output unit 42 stops the automatic closing operation in step S308 in FIG. 6. Then, the opening and closing command output unit 42 restarts the closing operation of the doors 12 in step S208 in FIG. 6, waits in step S209 in FIG. 6 until the closing operation of the doors 12 is ended, and ends the processing when the closing operation of the doors 12 is ended.

As described above, in the autonomous vehicle 10, in a case where the door opening and closing switch 26 is operated and a door opening signal or a door closing signal is received during the automatic opening and closing operation of the doors 12, the automatic opening and closing of the doors 12 is stopped by an interruption operation, and the doors 12 are opened or closed based on the operation of the door opening and closing switch 26. Accordingly, the doors 12 can be opened and closed as intended by the occupant even during the automatic opening and closing operation of the doors 12.

The autonomous vehicle 10 has been described as an autonomous battery electric vehicle (BEV) using the motor 51 and the battery 52 as drive sources in the above description, but the present disclosure is not limited thereto. The autonomous vehicle 10 may be a vehicle using an internal combustion engine as a drive source.

The automatic opening and closing determination unit 41 detects the positional relationship between a part of the occupant or the luggage and the handrail 20 and determines the entry into the stop prohibition area 30 based on the image acquired from one camera 35 with the handrail 20 as a reference object, but the present disclosure is not limited thereto. For example, two cameras 35 may be provided, and whether a part of the occupant or luggage enters the stop prohibition area 30 may be determined by calculating a three-dimensional position of the occupant or the luggage by the two cameras 35.

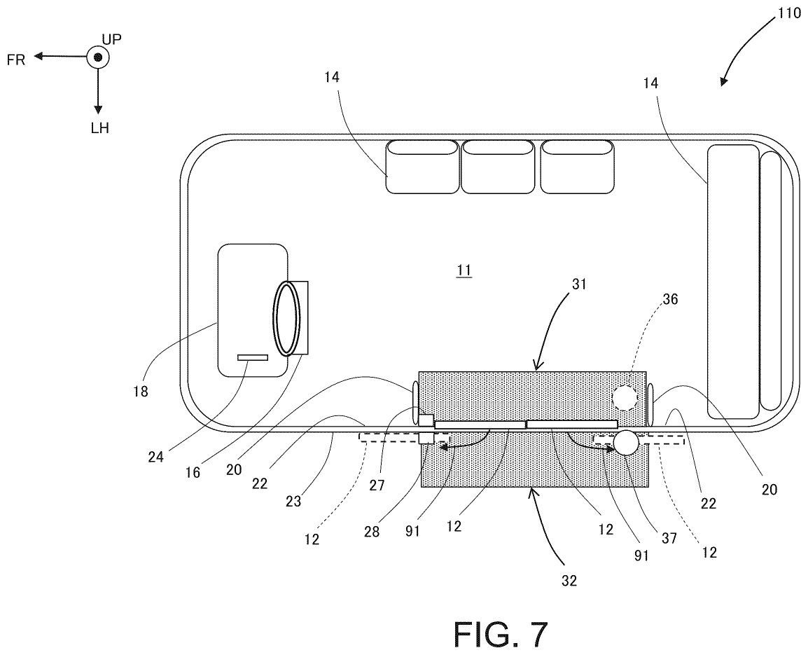

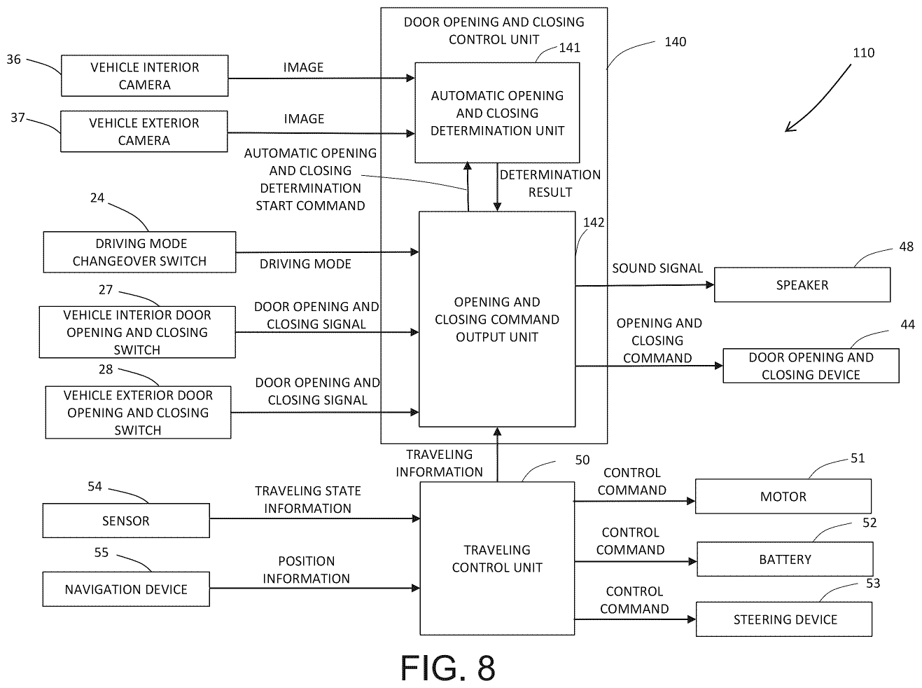

Next, an autonomous vehicle 110 according to another embodiment will be described with reference to FIGS. 7 and 8. The same components as those of the autonomous vehicle 10 described above with reference to FIGS. 1 to 6 are denoted by the same reference numerals, and the description thereof will be omitted.

As shown in FIG. 7, the autonomous vehicle 110 has two stop prohibition areas, that is, a vehicle interior stop prohibition area 31 set in a vicinity of the doors 12 in the vehicle interior 11 and a vehicle exterior stop prohibition area 32 set in an area in the vicinity of the doors 12 in a vehicle exterior. The vehicle interior stop prohibition area 31 has a quadrangle shape indicated by hatching in FIG. 7 in a top view, and is a three-dimensional rectangular parallelepiped area that extends from a floor surface of the vehicle interior 11 to the vicinity of upper ends of the doors 12. In addition, the vehicle exterior stop prohibition area 32 in the vehicle exterior has a quadrangle shape indicated by hatching in FIG. 7 in a top view, and is a three-dimensional rectangular parallelepiped area that extends from a road surface to the vicinity of upper end portions of the doors 12.

The autonomous vehicle 110 includes two cameras, that is, a vehicle interior camera 36 that is a vehicle interior imaging device for capturing an image of the vehicle interior 11 including the vehicle interior stop prohibition area 31 and a vehicle exterior camera 37 that is a vehicle exterior imaging device for capturing an image of the vehicle exterior including the vehicle exterior stop prohibition area 32. The vehicle interior camera 36 is provided at a ceiling portion of the vehicle interior 11 in the rear upper part of the vehicle interior stop prohibition area 31, and the vehicle exterior camera 37 is attached to an upper portion of an outer panel 23 in the rear of the vehicle exterior stop prohibition area 32.

The autonomous vehicle 110 further includes a vehicle interior door opening and closing switch 27 provided in the vehicle interior 11, and a vehicle exterior door opening and closing switch 28 provided in the vehicle exterior. The vehicle exterior door opening and closing switch 28 is provided adjacent to an opening portion of the door 12 on an outer side surface. The vehicle interior door opening and closing switch 27 and the vehicle exterior door opening and closing switch 28 are disposed in the vehicle interior stop prohibition area 31 and the vehicle exterior stop prohibition area 32, respectively.

The vehicle exterior door opening and closing switch 28 is attached in a manner of being substantially flush with the outer panel 23, and does not interfere with the door 12 when the door 12 is opened and closed. In FIG. 7, the vehicle exterior door opening and closing switch 28 is shown larger than the actual one for the sake of illustration.

As shown in FIG. 8, an automatic opening and closing determination unit 141 of a door opening and closing control unit 140 of the autonomous vehicle 110 receives images captured by the vehicle interior camera 36 and the vehicle exterior camera 37, and when an automatic opening and closing determination start command is received from an opening and closing command output unit 142, the automatic opening and closing determination unit 141 analyzes these images to determine whether or not the doors 12 can be automatically opened and closed, and outputs the determination result to the opening and closing command output unit 142. In a case where a target such as an occupant or luggage does not enter the vehicle interior stop prohibition area 31 and the target does not enter the vehicle exterior stop prohibition area 32, the automatic opening and closing determination unit 141 determines that the doors 12 can be automatically opened and closed, and outputs a determination result that the automatic opening and closing can be performed to the opening and closing command output unit 142. On the other hand, in a case where the target enters either the vehicle interior stop prohibition area 31 or the vehicle exterior stop prohibition area 32, the automatic opening and closing determination unit 141 determines that the doors 12 cannot be automatically opened and closed, and outputs a determination result that the automatic opening and closing cannot be performed to the opening and closing command output unit 142.

The opening and closing command output unit 142 receives an opening signal for the doors 12 or a closing signal for the doors 12 from the vehicle interior door opening and closing switch 27 and the vehicle exterior door opening and closing switch 28.

The opening and closing command output unit 142 drives the door opening and closing device 44 to perform automatic opening and closing of the doors 12 in a case where the determination result that the automatic opening and closing can be performed is received from the automatic opening and closing determination unit 141, and does not perform automatic opening and closing of the doors 12 in a case where the determination result that the automatic opening and closing cannot be performed is received from the automatic opening and closing determination unit 41.

In a case where an operation of either the vehicle interior door opening and closing switch 27 or the vehicle exterior door opening and closing switch 28 is performed and a door opening signal or a door closing signal is received from the vehicle interior door opening and closing switch 27 or the vehicle exterior door opening and closing switch 28, the opening and closing command output unit 142 executes the opening and closing of the doors 12 based on the operation of the vehicle interior door opening and closing switch 27 or the vehicle exterior door opening and closing switch 28 in preference to the automatic opening and closing of the doors 12 based on the determination result from the automatic opening and closing determination unit 141.

That is, in a case where the determination result that the doors 12 cannot be automatically opened and closed is received from the automatic opening and closing determination unit 141, and the operation of the vehicle interior door opening and closing switch 27 or the vehicle exterior door opening and closing switch 28 is performed and the door opening signal or the door closing signal is received, the opening and closing command output unit 142 prioritizes the operation of the vehicle interior door opening and closing switch 27 or the vehicle exterior door opening and closing switch 28 and outputs an opening and closing command for the doors 12 to the door opening and closing device 44 to open and close the door 12.

In a case where the determination result that the doors 12 can be automatically opened and closed is received from the automatic opening and closing determination unit 141, and the operation of the vehicle interior door opening and closing switch 27 or the vehicle exterior door opening and closing switch 28 is performed and the door opening signal or the door closing signal is received, the opening and closing command output unit 142 also prioritizes the operation of the vehicle interior door opening and closing switch 27 or the vehicle exterior door opening and closing switch 28 and outputs the opening and closing command for the doors 12 to the door opening and closing device 44 to perform opening and closing of the doors 12.

In a case where the determination result that the doors 12 can be automatically opened and closed is received from the automatic opening and closing determination unit 141 and the operation of the vehicle interior door opening and closing switch 27 or the vehicle exterior door opening and closing switch 28 is not performed, the opening and closing command output unit 142 performs automatic opening and closing of the doors 12.

Further, in a case where the operation of the vehicle interior door opening and closing switch 27 or the vehicle exterior door opening and closing switch 28 is performed during the automatic opening and closing of the doors 12, the opening and closing command output unit 142 stops the automatic opening and closing of the doors 12, and performs opening and closing of the doors 12 based on the operation of the vehicle interior door opening and closing switch 27 or the vehicle exterior door opening and closing switch 28.

The operation of the door opening and closing control unit 140 is the same as the operation of the door opening and closing control unit 40 described with reference to FIGS. 4 to 6 except that, in step S104 in FIG. 4 and step S211 in FIGS. 5 and 6, whether the automatic opening and closing of the doors 12 can be performed is determined based on whether a target enters either the vehicle interior stop prohibition area 31 or the vehicle exterior stop prohibition area 32 based on the images from the vehicle interior camera 36 and the vehicle exterior camera 37, and that the determination based on whether the door opening and closing switch 26 is operated in steps S105, S109, and S114 in FIG. 4 and steps S202 and S206 in FIGS. 5 and 6 is changed to determination based on whether either the vehicle interior door opening and closing switch 27 or the vehicle exterior door opening and closing switch 28 is operated.

As described above, in the autonomous vehicle 110, when the operation of the vehicle interior door opening and closing switch 27 or the vehicle exterior door opening and closing switch 28 is performed, the door opening and closing based on the operation of the vehicle interior door opening and closing switch 27 or the vehicle exterior door opening and closing switch 28 is preferentially executed regardless of the determination result from the automatic opening and closing determination unit 141, and thus interference between the door opening and closing based on the operation of the vehicle interior door opening and closing switch 27 or the vehicle exterior door opening and closing switch 28 performed by the occupant and the automatic opening and closing of the doors 12 can be prevented, and the doors 12 can be opened and closed as intended by the occupant.

In addition, in the autonomous vehicle 110, even in a case where the occupant enters either the vehicle interior stop prohibition area 31 or the vehicle exterior stop prohibition area 32 and the determination result that the automatic opening and closing cannot be performed is output from the automatic opening and closing determination unit 141, the doors 12 can be opened and closed by the operation of the vehicle interior door opening and closing switch 27 or the vehicle exterior door opening and closing switch 28 performed by the occupant. Therefore, the vehicle interior door opening and closing switch 27 or the vehicle exterior door opening and closing switch 28 is positioned in the vehicle interior stop prohibition area 31 or the vehicle exterior stop prohibition area 32, and even in a case where the occupant enters the vehicle interior stop prohibition area 31 or the vehicle exterior stop prohibition area 32 for the operation of the vehicle interior door opening and closing switch 27 or the vehicle exterior door opening and closing switch 28, the doors 12 can be opened and closed as intended by the occupant.

1. An autonomous vehicle, comprising:
a stop prohibition area that is set in a vicinity of a door;
an imaging device that captures an image of an area including the stop prohibition area;
a door opening and closing control unit that analyzes the image to determine whether the door is automatically openable and closable, and performs automatic opening and closing of the door in a case where it is determined that the door is automatically openable and closable; and
a door opening and closing switch that is provided in the vicinity of the door and opens and closes the door upon operation by an occupant, wherein
when an operation of the door opening and closing switch is performed, the door opening and closing control unit executes opening and closing of the door based on the operation of the door opening and closing switch in preference to the automatic opening and closing of the door based on the determination on the image.

2. The autonomous vehicle according to claim 1, wherein
the door opening and closing control unit
analyzes the image to detect whether a target enters the stop prohibition area,
determines that the door is automatically openable and closable and performs the automatic opening and closing of the door in a case where the target does not enter the stop prohibition area,
determines that the door is not automatically openable and closable and does not perform the automatic opening and closing of the door in a case where the target enters the stop prohibition area, and
performs the opening and closing of the door based on the operation of the door opening and closing switch in a case where it is determined that the door is not automatically openable and closable and the operation of the door opening and closing switch is performed.

3. The autonomous vehicle according to claim 1, wherein
the door opening and closing control unit stops the automatic opening and closing of the door and performs the opening and closing of the door based on the operation of the door opening and closing switch in a case where the operation of the door opening and closing switch is performed during the automatic opening and closing of the door.

4. The autonomous vehicle according to claim 2, wherein
the door opening and closing control unit stops the automatic opening and closing of the door and performs the opening and closing of the door based on the operation of the door opening and closing switch in a case where the operation of the door opening and closing switch is performed during the automatic opening and closing of the door.

5. The autonomous vehicle according to claim 1, wherein
the stop prohibition area is set in a vehicle interior, and
the imaging device and the door opening and closing switch are provided in the vehicle interior.

6. The autonomous vehicle according to claim 2, wherein
the stop prohibition area is set in a vehicle interior, and
the imaging device and the door opening and closing switch are provided in the vehicle interior.

7. The autonomous vehicle according to claim 1, wherein
the stop prohibition area includes a vehicle interior stop prohibition area set in a vehicle interior and a vehicle exterior stop prohibition area set in a vehicle exterior,
the imaging device includes a vehicle interior imaging device that captures a vehicle interior image of a vehicle interior area including the vehicle interior stop prohibition area, and a vehicle exterior imaging device that captures a vehicle exterior image of a vehicle exterior area including the vehicle exterior stop prohibition area,
the door opening and closing switch is individually provided at the vehicle interior and the vehicle exterior,
the door opening and closing control unit analyzes the vehicle interior image and the vehicle exterior image to determine whether the door is automatically openable and closable, and performs automatic opening and closing of the door in a case where it is determined that the door is automatically openable and closable, and
when an operation of one door opening and closing switch of the plurality of door opening and closing switches is performed, the opening and closing of the door based on the operation of the one door opening and closing switch is executed in preference to the automatic opening and closing of the door based on the determination on the vehicle interior image and the vehicle exterior image.

8. The autonomous vehicle according to claim 7, wherein
the door opening and closing control unit
analyzes the vehicle interior image and the vehicle exterior image to detect whether a target enters the vehicle interior stop prohibition area or the vehicle exterior stop prohibition area,
determines that the door is automatically openable and closable and performs the automatic opening and closing of the door in a case where the target does not enter the vehicle interior stop prohibition area or the vehicle exterior stop prohibition area,
determines that the door is not automatically openable and closable and does not perform the automatic opening and closing of the door in a case where the target enters the vehicle interior stop prohibition area or the vehicle exterior stop prohibition area, and
performs the opening and closing of the door based on an operation of one door opening and closing switch of the plurality of door opening and closing switches in a case where it is determined that the door is not automatically openable and closable and the operation of the one door opening and closing switch is performed.

9. The autonomous vehicle according to claim 7, wherein
the door opening and closing control unit stops the automatic opening and closing of the door and performs the opening and closing of the door based on an operation of one door opening and closing switch of the plurality of door opening and closing switches in a case where the operation of the one door opening and closing switch is performed during the automatic opening and closing of the door.

10. The autonomous vehicle according to claim 8, wherein
the door opening and closing control unit stops the automatic opening and closing of the door and performs the opening and closing of the door based on an operation of one door opening and closing switch of the plurality of door opening and closing switches in a case where the operation of the one door opening and closing switch is performed during the automatic opening and closing of the door.
